(19) United States
(12) Patent Application Publication
(10) Pub. No.: US 2012/0283060 A1
(43) Pub. Date: Nov. 8, 2012

(54) LUBRICATION DISTRIBUTION WITHIN REAR DRIVE MODULE

(75) Inventor: Richard Harold Birdsall, III, Northville, MI (US)

(73) Assignee: AMERICAN AXLE & MANUFACTURING, INC., Detroit, MI (US)

(21) Appl. No.: 13/098,847

(22) Filed: May 2, 2011

(51) Int. Cl. F16H 47/08; F16H 48/06

(52) U.S. Cl. 475/31

(57) ABSTRACT

A power transmission device constructed in accordance to one example of the present teachings includes a torque transfer device and a differential. The torque transfer device includes a housing. The torque transfer device selectively communicates rotatable motion from an input member to an output member. A frictional clutch is disposed in the housing that actuates to selectively transfer torque between the input member and the output member. A first and a second axle shaft selectively drives a first and a second drive wheel, respectively. The differential selectively transfers drive torque from the output member to at least one of the first and second axle shafts. A fluid distribution system distributes a common fluid for actuating the frictional clutch and for lubricating select components of the differential.

### FIELD

The present disclosure relates generally to power transmission devices having a torque transfer device and a differential. More particularly, the present disclosure is directed to a fluid distribution system configured to utilize a common fluid for creating hydraulic pressure in the torque transfer device as well as for target lubricating select components of the differential.

### BACKGROUND

This section provides background information related to the present disclosure which is not necessarily prior art.

Due to increased demand for four-wheel drive and all-wheel drive vehicles, many power transmission systems are being incorporated into vehicle driveline applications for transferring drive torque to the wheels. Many vehicles include a power transmission device operably installed between the primary and secondary drivelines. Such power transmission devices are typically equipped with a torque transfer device for selectively transferring drive torque from the primary driveline to the secondary driveline to establish a four-wheel drive mode of operation. In many examples, a differential is incorporated on the secondary driveline that receives an input from the torque transfer mechanism. The differential selectively transmits the drive torque to a pair of axle shafts.

Proper lubrication is one of the most important aspects of a vehicle driveline. A primary function of lubrication is to reduce friction between moving parts, increase corrosion resistance and dissipate heat from the moving components in the driveline. Traditional drivelines use the rotation of a ring gear, pinion, and other masses to transfer the lubrication throughout the driveline. As the masses rotate, they pick up the lubricant and distribute it around the inside of the assembly. Traditional drivelines have oil channels built into the assemblies to allow for the lubrication to reach other key internal areas. This form of lubrication requires a portion of the ring gear, or other rotating mass, to be submerged in the lubricant. If the lubricant level is too low, the lubricant will not be dispersed sufficiently around the inside of the driveline.

### SUMMARY

This section provides a general summary of the disclosure, and is not a comprehensive disclosure of its full scope or all of its features.

A power transmission device constructed in accordance to one example of the present teachings includes a torque transfer device and a differential. The torque transfer device includes a housing. The torque transfer device selectively communicates rotatable motion from an input member to an output member. A frictional clutch is disposed in the housing that actuates to selectively transfer torque between the input member and the output member. A first and a second axle shaft selectively drives a first and a second drive wheel, respectively. The differential selectively transfers drive torque from the output member to at least one of the first and second axle shafts. A fluid distribution system distributes a common fluid for actuating the frictional clutch and for lubricating select components of the differential.

According to additional features, the select components include a first and a second differential bearing associated with the first and second axle shafts. These select components further include a head and a tail bearing associated with the output member. The fluid distribution system also distributes fluid to an interface between the output member and ring gear of the differential. The fluid distribution system comprises a hydraulic power pack that distributes the fluid to the components through at least one fluid line. According to one example, the hydraulic power pack comprises a fluid pump.

According to other features of the present disclosure, the fluid distribution system further comprises a conduit that communicates the fluid from the hydraulic power pack to a piston that responsively regulates an engagement force applied to the frictional clutch. A return fluid line communicates the fluid from the differential to the hydraulic power pack. According to one configuration, the differential is a rear differential and the first and second axle shafts are first and second rear axle shafts.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

The present invention will become more fully understood from the detailed description and the accompanying drawings wherein:

FIG. 1 is a schematic of a four-wheel drive vehicle equipped with a power transmission device incorporating a lubrication distribution system in accordance to one example of the present teachings;

FIG. 2 is a schematic of the power transmission device of FIG. 1;

FIG. 3 is a perspective view of the power transmission device of FIG. 2 incorporating the lubrication distribution system and having external fluid lines according to one implementation of the present teachings;

FIG. 4 is a partial sectional view of the power transmission device of FIG. 3 illustrating an exemplary fluid distribution path according to one example of the present teachings; and

FIG. 5 is a partial sectional view of the power transmission device of FIG. 3 and illustrating an exemplary return fluid path according to one example of the present teachings.

Corresponding reference numerals indicate corresponding parts throughout the several views of the drawings.

### DETAILED DESCRIPTION

Example embodiments will now be described more fully with reference to the accompanying drawings.

The following description of the preferred embodiments is merely exemplary in nature and is in no way intended to limit the invention, its application, or uses.

The present invention is directed to a power transmission device including a torque transfer device and a rear differential that may be adaptively controlled for modulating the torque transferred between a rotatable input member and a rotatable output member. The power transmission device described herein is specific to a rear drive module, however other applications such as transmission devices incorporated on a front drive module are contemplated. Accordingly, while the present invention is hereinafter described in association with a specific structural embodiment for use as a rear drive module in a driveline application, it should be understood that the arrangement shown and described is merely intended to illustrate an exemplary embodiment of the present invention.

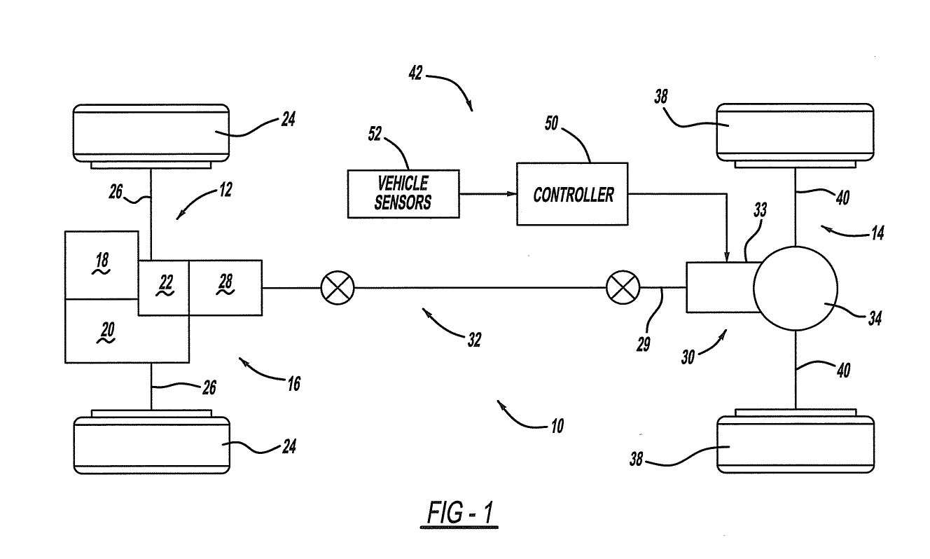

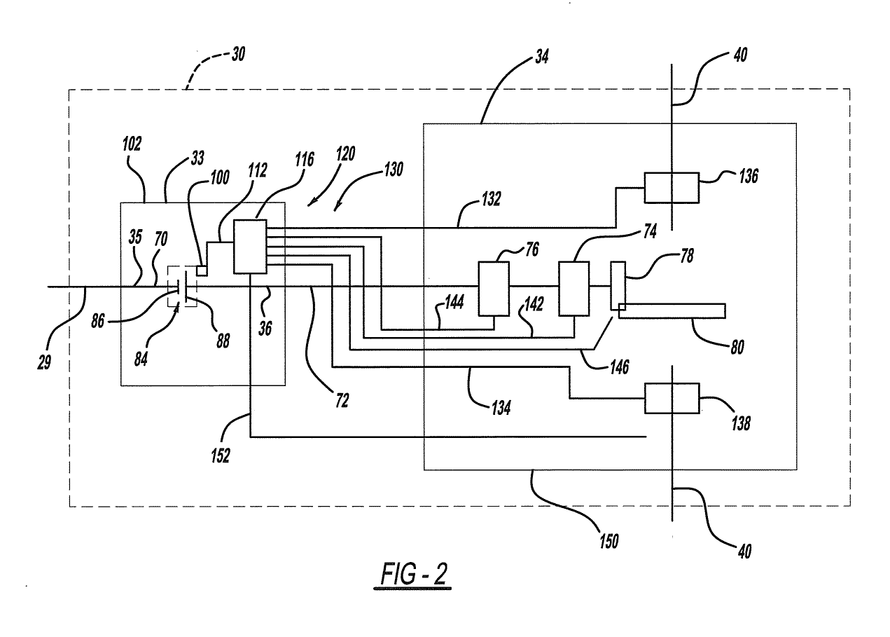

With initial reference to FIGS. 1 and 2 of the drawings, a drive train 10 for a four-wheel vehicle is shown. The drive train 10 includes a first axle assembly 12, a second axle assembly 14, and a powertrain assembly 16 for generating and delivering drive torque to the axle assemblies 12 and 14, respectively. In the particular arrangement shown, the first axle assembly 12 is the front axle while the second axle assembly 14 is the rear axle. The powertrain assembly 16 includes an engine 18 and a multi-speed transmission 20 having an integrated front differential unit 22 for driving front wheels 24 via front axle shafts 26. The powertrain assembly 16 further includes a transfer unit 28 driven by the transmission 20 for delivering torque to an input member 29 of a power transmission device 30 via a drive shaft assembly 32. The power transmission device 30 generally includes a torque transfer device 33 and a rear differential 34. The input member 29 of the power transmission device 30 corresponds to an input member 35 of the torque transfer device 33 and is coupled to the drive shaft assembly 32. An output member 36 (FIG. 2) of the torque transfer device 33 is arranged to drive the rear differential 34. The second axle assembly 14 also includes a pair of wheels 38 that are connected to the rear differential 34 via rear axle shafts 40.

The drive train 10 is shown to include an electronically-controlled power transfer system 42 that includes the power transmission device 30. The power transfer system 42 is operable to selectively provide drive torque in a two-wheel drive mode or a four-wheel drive mode. In the two-wheel drive mode, torque is not transferred via the torque transfer device 33 of the power transmission device 30. Accordingly, one hundred percent of the drive torque delivered by the transmission 20 is provided to the front wheels 24. In the four-wheel drive mode, power is transferred through the torque transfer device 33 of the power transmission device 30 to supply drive torque to the rear wheels 38. The power transfer system 42 further includes a controller 50 that is in communication with vehicle sensors 52 for detecting dynamic and operational characteristics of the motor vehicle. The vehicle sensors 52 can include, but are not limited to, sensors that can determine wheel speed, wheel slip, steering wheel angle, yaw rate, throttle position, engine/transmission torque, vehicle speed, stability control, etc.

The controller 50 is operable to control actuation of the torque transfer device 34 in response to signals from the vehicle sensors 52. The controller 50 may be programmed with a predetermined target torque split between the first and second set of wheels 24 and 38, respectively. Alternatively, the controller 50 may function to determine the desired torque to be transferred through the torque transfer device 33 via other methods. Regardless of the method used for determining the magnitude of torque to transfer, the controller 50 operates the torque transfer device 33 to maintain the desired torque magnitude.

With specific attention now to FIG. 2, the torque transfer device 33 of the power transmission device 30 will be described in greater detail. The input member 35 of the torque transfer device 33 is shown to include an input shaft 70 while the output member 36 is shown to include an output shaft 72. The output shaft 72 is preferably a pinion shaft supported by head and tail bearings 74 and 76, respectively. The output shaft 72 has a pinion gear 78 that is meshed for rotation with a ring gear 80 on the rear differential 34. The power transmission device 30 also includes a friction clutch 84 that is operably dispersed between the input shaft 70 and the output shaft 72. The friction clutch 84 can comprise a first clutch plate 86 and a second clutch plate 88. In one configuration, the input shaft 70 includes a clutch hub (not specifically shown) that is drivingly coupled to the first friction plate 86. Similarly, the second clutch plate 88 is arranged in a splined engagement with a clutch drum (not specifically shown). The drum is drivingly coupled to the output shaft 72. The friction clutch 84 is a wet clutch. While the first and second clutch plates 86 and 88, respectively, are both represented as a single clutch plate, a set of clutch plates including multiple first and second clutch plates can be provided in an interleaved configuration.

A piston 100 is slidably positioned within a cavity that is formed within a housing 102 of the torque transfer device 33. The piston 100 is axially movable in response to pressurized fluid that flows through a conduit 112 formed in the housing 102 to control actuation of the friction clutch 84. Other configurations are contemplated. When pressurized fluid builds on the face of the piston 100, the piston 100 translates and applies a force such as through a thrust bearing and apply plate (not specifically shown) to the clutch plates 86 and 88. Torque is transferred between the input shaft 70 and the output shaft 72 when the friction plates 86 and 88 are forced into contact with one another. A hydraulic power pack 116 is arranged to provide a controllable source of pressurized fluid to the conduit 112. Regulation of the fluid pressure in the conduit 112 acts to proportionally regulate the clutch engagement force applied by the piston 100 which, in turn, regulates the drive torque transferred from the input shaft 70 to the output shaft 72. While not limited thereto, the power pack 116 can include a motor-driven fluid pump and valving for controlling the fluid pressure delivered to the conduit 112.

With reference now to FIGS. 2-5, a fluid distribution system 120 constructed in accordance to one example of the present teachings will be described. In general, the fluid distribution system 120 includes the hydraulic power pack 116 that communicates pressurized fluid through the conduit 112 to the piston 100. The fluid distribution system 120 also includes a plurality of lubrication delivery lines collectively identified at reference numeral 130 that deliver the pressurized fluid from the hydraulic power pack 116 to various components of the rear differential 34. While the term “line” is used herein to denote the structure used to transport the fluid from the hydraulic power pack 116 to the various components of the rear differential 34, it will be appreciated that the term encompasses other structures such as pipes, tubes, channels or other forms of enclosed spaces.

In the particular example shown, the lubrication delivery lines 130 include first and second fluid delivery lines 132 and 134 that communicate fluid from the hydraulic power pack 116 to first and second differential bearings 136 and 138, respectively. The lubrication delivery lines 130 further comprise a third fluid delivery line 142 and fourth fluid delivery line 144. The third fluid delivery line 142 communicates fluid from the hydraulic power pack 116 to the head bearing 74. The fourth fluid delivery line 144 communicates fluid from the hydraulic power pack 116 to the tail bearing 76. A fifth fluid delivery line 146 communicates fluid from the hydraulic power pack 116 to an interface between the pinion 78 and the ring gear 80. The lubrication delivery lines 130 of the fluid distribution system 120 therefore communicate fluid from the hydraulic power pack 116 to specific components of the rear differential 34. Once the fluid is dispersed onto the identified components, the fluid then collects in a housing 150 of the differential 34 where a return line 152 routes the fluid back to the hydraulic power pack 116 where the process is repeated.

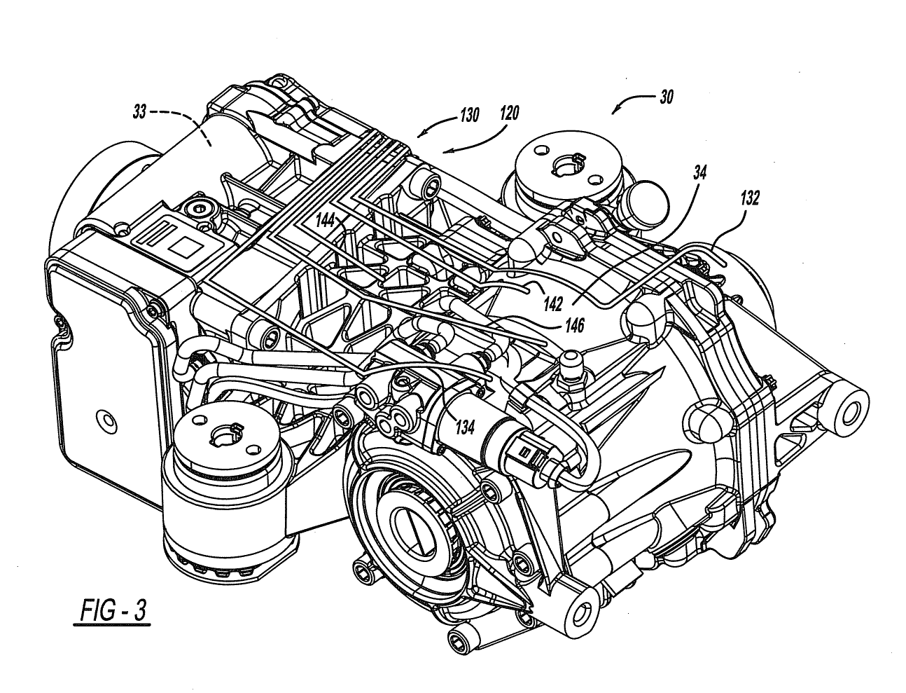

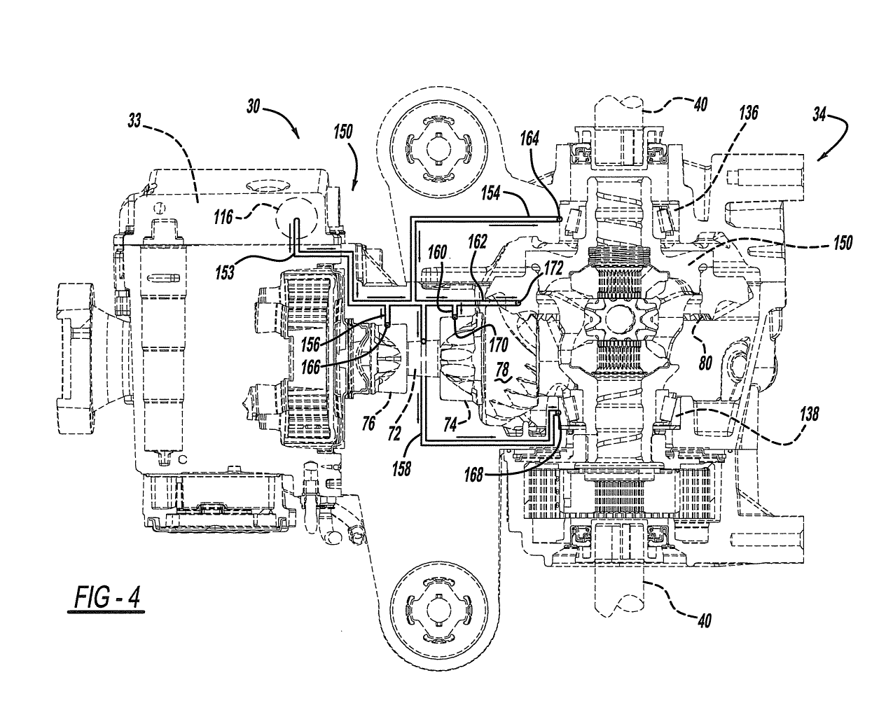

It is appreciated that while the schematic representation of the fluid distribution system 120 shown in FIG. 2 identifies dedicated or distinct fluid distribution lines 130 used to route the fluid to the identified components, other configurations are contemplated. For example, some or all of the lubrication delivery lines 130 may be shared for delivering fluid from the hydraulic power pack 116 to more than one component. It will also be understood that the lubrication lines 130 can be routed externally to the power transfer device 30 as illustrated in FIG. 3. Alternatively, the lubrication lines 130 may be formed at least partially within the sidewall 102 of the torque transfer device 33 and/or the housing 150 of the differential 34 such as during a casting process. Other configurations are contemplated. For example, as illustrated in the cross-sectional representation of FIG. 4, lubrication lines 150 constructed in accordance to another example of the present disclosure are shown that incorporate partially shared fluid line paths to the dedicated components of the differential 34. Specifically, the lubrication lines 150 include a first fluid line portion 153 that initiates at the hydraulic power pack 116 and connects with a second fluid line portion 154, a third fluid line portion 156, a fourth fluid line portion 158, a fifth fluid line portion 160 and a sixth fluid line portion 162. The second fluid line portion 154 has an outlet 164 that is proximate the differential bearing 136 for dispersement of fluid thereon. The third fluid line portion 156 includes an outlet 166 that is aligned for dispersing fluid onto the tail bearing 76. The fourth fluid line portion 158 includes an outlet 168 that is aligned to disperse fluid onto the differential bearing 138. The fifth fluid line portion 160 includes an outlet 170 that is aligned to disperse fluid onto the head bearing 74. The sixth fluid line portion 162 includes an outlet 172 that is aligned to disperse fluid onto an interface between the pinion 78 and ring gear 80. The outlets 164, 166, 168, 170 and 172 may comprise an orifice and/or nozzle sized to accommodate an optimal line pressure, exit diameter, flow rate, etc.

While the return line 152 has been described above as collecting the dispersed fluid from the identified components in the housing 150 and returning the fluid to the hydraulic power pack 116 through a single line, it is contemplated that multiple return lines may be incorporated. Again, the return lines may be provided externally to the power transmission device 30 or alternatively may be formed as part of the housing 102 of the torque transfer device 33 and/or the housing 150 of the rear differential 34.

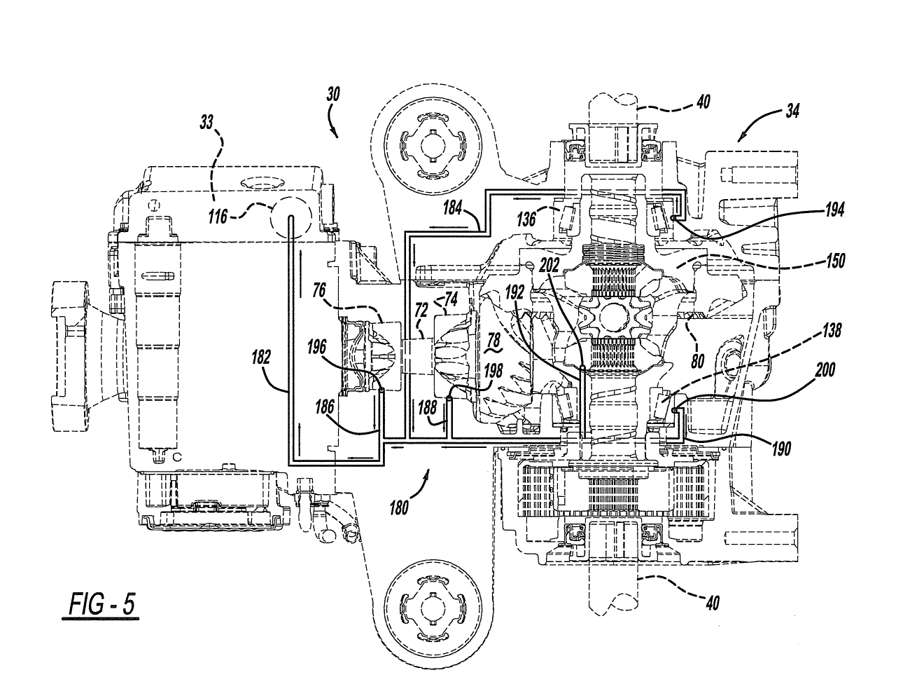

Turning now to FIG. 5, a return line configuration is shown according to another example and generally identified at reference numeral 180. The return line 180 can collectively be formed by a first return line portion 182, a second return line portion 184, a third return line portion 186, a fourth return line portion 188, and a fifth return line portion 190 and a sixth return line portion 192. The first return line portion 182 is generally located downstream of the other return line portions and is configured to route the fluid back to the hydraulic power pack 116. The second return line portion 184 has an inlet 194 proximate the differential bearing 136. The third return line portion 186 has an inlet 196 proximate the tail bearing 76. The fourth return line portion 188 has an inlet 198 proximate the head bearing 74. The fifth return line portion 190 has an inlet 200 generally proximate the rear differential bearing 138. The sixth return line portion 192 has an inlet 202 generally proximate the pinion 78 and ring gear 80. Again, it will be appreciated that other configurations may be provided. Nevertheless, the return line 180 communicates the fluid that was distributed through the lubrication delivery lines 130 back to the hydraulic power pack 116.

The power transmission device 30 of the present disclosure allows for a single lubrication to be used to apply the friction clutch 84 as well as lubricate dedicated components of the rear differential 34. In this regard, it is not necessary to include multiple fluids of different viscosity and/or other properties for the power transmission device 30. It will be appreciated that while the above description has been made with respect to the lubrication lines 130 providing directed lubrication onto the head bearing 74, the tail bearing 76, the differential bearings 136 and 138 as well as the interface between the pinion 78 and the ring gear 80, the lubrication lines 130 may include other lines that are routed elsewhere to specifically target lubrication onto other components of the differential 34.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A power transmission device comprising:
a torque transfer device including a housing, the torque transfer device selectively communicating rotatable motion from an input member to an output member;
a frictional clutch disposed in the housing that actuates to selectively transfer torque between the input member and the output member;
a first and a second axle shaft that selectively drive a first and a second drive wheel, respectively;
a differential that selectively transfers drive torque from the output member to at least one of the first and second axle shafts; and
a fluid distribution system that distributes a common fluid for actuating the frictional clutch and for lubricating select components of the differential.

2. The power transmission device of claim 1 wherein the select components include a first and a second differential bearing associated with the first and second axle shafts, respectively.

3. The power transmission device of claim 2 wherein the select components include a head and a tail bearing associated with the output member.

4. The power transmission of claim 1 wherein the select components include an interface between the output member and a ring gear of the differential.

5. The power transmission of claim 1 wherein the fluid distribution system comprises a hydraulic power pack that distributes the fluid to the components through at least one fluid line.

6. The power transmission of claim 5 wherein the hydraulic power pack comprises a fluid pump.

7. The power transmission of claim 5 wherein the fluid distribution system further comprises a conduit that communicates the fluid from the hydraulic power pack to a piston that responsively regulates an engagement force applied to the frictional clutch.

8. The power transmission of claim 5, further comprising a return fluid line that communicates the fluid from the differential to the hydraulic power pack.

9. The power transmission of claim 1 wherein the differential is a rear differential and the first and second axle shafts are first and second rear axle shafts.

10. A power transmission device comprising:
a torque transfer device including a housing, the torque transfer device selectively communicating rotatable motion from an input member to an output member;
a wet clutch disposed in the housing that actuates to selectively transfer torque between the input member and the output member;
a rear differential that selectively transfers drive torque from the output member to at least one of a pair of axle shafts; and
a fluid distribution system including a hydraulic power pack that delivers a common fluid to the wet clutch and to at least one component of the differential for target distributing the fluid onto the at least one component of the rear differential.

11. The power transmission device of claim 10 wherein the at least one component includes a pair of differential bearings associated with the respective pair of axle shafts.

12. The power transmission device of claim 11 wherein the at least one component further includes a head and a tail bearing associated with the output member.

13. The power transmission of claim 12 wherein the at least one component further includes an interface between the output member and a ring gear of the rear differential.

14. The power transmission of claim 10 wherein the hydraulic power pack comprises a fluid pump that distributes the fluid to the at least one component through at least one fluid line.

15. The power transmission of claim 10 wherein the fluid distribution system further comprises a conduit that communicates the fluid from the hydraulic power pack to a piston that responsively regulates an engagement force applied to the wet clutch.

16. The power transmission of claim 15, further comprising a return fluid line that communicates the fluid from the rear differential to the hydraulic power pack.

17. A power transmission device comprising:
a torque transfer device including a housing, the torque transfer device selectively communicating rotatable motion from an input member to an output member;
a frictional clutch disposed in the housing that actuates to selectively transfer torque between the input member and the output member;
a piston that translates causing the frictional clutch to actuate in response thereto;
a first and a second axle shaft that selectively drive a first and a second drive wheel, respectively;
a differential that selectively transfers drive torque from the output member to at least one of the first and second axle shafts;
a fluid distribution system including a hydraulic power pack that distributes a common fluid to the piston for actuating the frictional clutch and that delivers the fluid to select outlets located on the differential at locations proximate to select components of the differential; and
a return fluid line that delivers the fluid from the differential back to the hydraulic power pack.

18. The power transmission device of claim 17 wherein the select components include a first and second differential bearing associated with the first and second axle shafts, respectively, a head and tail bearing associated with the output member and an interface between the output member and a ring gear of the differential.

19. The power transmission of claim 18 wherein the hydraulic power pack comprises a fluid pump that distributes the fluid to the select components through at least one fluid line.

20. The power transmission of claim 19 wherein the fluid distribution system further comprises a conduit that communicates the fluid from the hydraulic power pack to a piston that responsively regulates an engagement force applied to the frictional clutch.
